(19) United States
(12) Patent Application Publication
(10) Pub. No.: US 2025/0036705 A1
(43) Pub. Date: Jan. 30, 2025

(54) SYSTEM FOR OPTIMIZING WEBPAGES

(71) Applicant: Warpfactor, Inc., Austin, TX (US)

(72) Inventor: Raymond J. Westwater, Austin, TX (US)

(21) Appl. No.: 18/714,682

(22) PCT Filed: Dec. 17, 2021
(86) PCT No.: PCT/US2021/064064

§ 371 Date: May 30, 2024

(51) Int. Cl. G06F 16/957; G06F 16/958

(52) U.S. Cl. CPC G06F 16/9574; G06F 16/958

(57) ABSTRACT

Techniques are described for a system to automate auditing and updating of pages associated with one or more websites. In some cases, the system may be configured to simulate, or test load a page of a website and determine page code edits to improve load time.

### BACKGROUND

Today, many search engines rank websites and webpages based at least in part on a rate or frequency of content updates, one or more server efficiency metrics, a last date of update, and a recency or relevancy of the sites code base. Further, the website or webpage often needs to be optimized or customized for each device-browser combination to provide both a pleasant user experience and an expected performance. However, for many businesses and individuals, regularly updating a website or webpage as well as keeping the code relevant for the multiple device-browser combinations not only requires periodic creation of up to date content but also employment of an available developer to implement the changes on a regular basis. Unfortunately, many of these businesses and individuals cannot afford a full time or even part time developer, resulting in use of a user-friendly webpage authoring system, introducing inefficiencies resulting in a website and webpages being overlooked in searches and increased resource demand on the servers when delivering the content to client devices.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a view of an example system to improve website performance, according to some implementations.

FIG. 2 is a view of an example system to improve website performance, according to some implementations.

FIG. 3 is a flow diagram illustrating an example process associated with the systems of FIG. 1 or 2 according to some implementations.

FIG. 4 is a flow diagram illustrating an example process associated with the systems of FIG. 1 or 2 according to some implementations.

FIG. 5 is a flow diagram illustrating an example process associated with updating page code according to some implementations.

FIG. 6 is a flow diagram illustrating an example process associated with updating page code according to some implementations.

FIG. 7 is a flow diagram illustrating an example process associated with updating page code according to some implementations.

FIG. 8 is an example of a maintenance and monitoring systems of FIG. 1 or 2 application according to some implementations.

### DETAILED DESCRIPTION

Search engines are often accessed by users to quickly and easily identify a web location or uniform resource locator (URL) that is associated with or otherwise related to the search terms. In this manner, the search engines control large amounts of online content being delivered to and accessed by individual users. The search engines often have a ranking system, such that the URLs or links associated with higher ranking websites or online content items are prioritized, presented and/or delivered at the top of the search results. In many cases, the quality of the website, recency of the website code and content, the initial load time of the website as well as other website related metrics are used in combination with matching of the content to the search terms when the search engines rank and present the URLs. As a result, websites that can employ full time or part time programmers to audit, update, and optimize the site on a regular basis often rank higher with respect to search engine results than pages or content associated with websites that cannot afford such programmers.

Discussed herein, is a system to access, audit, update, and/or optimize websites via an automated process that improves load time of the websites, network resource consumption by the website, and overall server resource consumption associated with hosting and maintaining the website. The updates and optimizations of the website code may also improve the search result ranking of a website, thereby allowing the content to be more readily consumed by internet or network users.

In some examples, a user or owner of a site may register a website, page, or URL with the system. The system may then access the code of the website to perform an initial audit and/or update as well as various regular audits and/or updates, such as periodic or time-based audits, administrator triggered audits, website update triggered audits (e.g., the website owner updates the site content or code), and the like. During an audit, the system may perform various tests and measure performances (such as initial load time) and apply various code optimizations and/or updates based on the results of the tests.

Initially, during the preliminary audit, the system may determine if the website is a static page or a dynamic page. As used herein a dynamic page is any page that delivers personalized content based on a known user login or account accessing the content, such as, for example, via a database query that triggered on a page load or as part of an in page access to the host system. And static pages are any page that does not qualify as a dynamic page including pages that provide dynamic content that is not personalized (e.g., pages whose content changes but is not personalized based on a user login or account). As discussed herein, the system may, for the dynamic pages, identify portions of pages and/or pages that include static content and perform the audit, updates, and/or optimizations, discussed below, with respect to the static pages. The system may then perform additional testing and updates for the dynamic content.

In one example, the system may initially cause individual pages of the site to load allowing the load-time document object models (DOMs) to complete any changes to the site. The system may then export the modified DOM code as a loaded page, e.g., a fully loaded hypertext markup language (HTML) page. The system may parse individual loaded pages and identify one or more instance of immediately-executable scripts. The system may then replace the immediately-executable scripts with newly generated static page code to generate a fast static web page. The system may then update the website page based at least in part on the fast static web page to reduce the number of immediately-executable scripts that execute when the page is accessed by a user. By removing the immediately-executable scripts the page load time may be improved thereby improving search result rankings and reducing network resource consumption.

In some cases, the system may also identify via the parsing instances of cascading style sheets (CSS) elements and/or plugins that modify the CSS of the individual pages. For example, many scripting languages and/or page content management systems allow users to insert plugins or code segments (such as open source code segments) that are self-contained and include CSS modifications associated with the plugin to cause the plugin to display appropriately without custom coding. In this manner, many novice programmers are able to quickly and efficiently build quality webpages. However, many search engines do not consider a page to be loaded until the CSS from each individual plugin is applied and used to modify the DOM tree of the page. Accordingly, pages that include more plugins have slower load times resulting in these pages ranking lower with respect to pages that were custom built by an experienced programmer. In these cases, the system, discussed herein, may identify the CSS modules associated with the plugins during the testing and parsing of the loaded page. The system may then remove the CSS elements from the code associated with the plugin and apply the CSS modifications into a header of the page to, thereby, stabilize the CSS tree upon execution of the header portion of the page. In this manner, the page is allowed to completely load and/or to be considered loaded prior to execution of the plugin. Accordingly, the load time of the page is reduced, and the search engine rankings may be improved.

In addition to moving the CSS modifications from the plugins to the header of a page, the system may also consolidate the CSS code and remove any redundant changes. For instance, two plugins may cause the same CSS modifications, or the CSS modification requested by a plugin may already have been applied as a default for the page. In these cases, the system may identify the redundant changes and remove the code thereby reducing the size of the code and the load time (e.g., the same modification is no longer applied multiple times during load). In some case, the system may also modify the code to reduce the overall number and size of the CSS files. For instance, by reducing the number of CSS files (e.g., consolidating the files), the page may be loaded in a more efficient manner as the file access times are reduced. Likewise, if a CSS file is too large the file may be partitioned into multiple files to, for instance, load in parallel. In some cases, the system may determine a file size and/or number based on an available bandwidth, such as associated with the host system or server.

As an illustrative example, the system may serve 10 files to a browser. In this example, the browser may experience a 10 millisecond delay for each additional file that is being loaded in parallel. Thus, in this example, the browser may experience a 100 milliseconds delay from having 10 parallel file and the system may improve the load time by up to 100 milliseconds (e.g., the delay) by combining the 10 individual files into a single file. In this example, CSS files are discussed, but it should be understood that the system may consolidate files for various elements of a page, including but not limited to, JavaScript, CSS, still image files, video files, and other object related plugins.

In some examples, the system may also identify instances of JavaScript code within the loaded page and monitor the JavaScript during testing to determine first elements of the JavaScript that are executed or referenced on load. For instance, JavaScript may include the first elements that are executed or referenced on load and other elements (e.g., second elements) that are executed at a later time or unreferenced on load. Once, the first elements of the JavaScript are identified, the system may adjust the page code such that the first elements of the JavaScript executes as an initial loadable unit and the second elements are packaged as a delayed load or interactive load thereby reducing load time code execution and improving the overall load time of the page. In some cases, either the first elements and/or the second elements of the JavaScript may include modifications to the CSS tree. In these case, similar to the plugins discussed above, the system may consolidate and move the CSS modifications to the header to further improve load time performance of pages utilizing JavaScript.

In some examples, the system may also identify still images and/or video content associated with a page. For example, conventional systems may utilize browser extensions for image and/or video content as the size and shape of displays and the number of browsers have both increased. In these conventional systems, the browser extensions may allow a page to include multiple images or videos of various dimensions that may be served to a browser during load. The browser extension may then select the image and/or video content to display based on the browser and/or device characteristics. However, in the case that an advanced browser technology is unsupported, load time is an issue, as the system defaults to a single image for all cases. In the case that the advanced technology is supported, image optimization becomes a burdensome programming problem.

Accordingly, the system discussed herein, may identify each of the multiple image files and/or video content files associated with the page. The system may then generate a page for each of the browser/device combinations typically selected by the browser extension. The system discussed herein may then be configured to, upon a request to view or load the page by a browser, determine the characteristics of the browser/device. The system may then select one of the pages (e.g., the page most closely matching the browser/device configuration) and serve only the page with single image files and video files, thereby reducing the overall load time (e.g., as fewer files are sent to the browser/device). In some alterative cases, the system may alter the image and/or video files on demand prior to serving the browser/device. For example, the system may determine the characteristics of the browser/device, modify the image files and/or video files based on the determination and then serve the page including the modified image files.

As a specific example, in some instance, each browser may require different file types, such as WebP, JPEG, PNG, or the like. In this example, the system may also determine not only the size of the images and/or video content based on, for instance, the display size or browser being used but the type of file format to provide to the browser/device. For example, the system may select the file type that is preferred by each individual browser, as some browsers provide higher ranking when the preferred file type is used by a page. In some cases, the system may also identify images and/or video content that is below the “fold” or the bottom edge of the display (based on the browser/device characteristics) and mark each of the images and/or video content as a delayed load unit to further improve the initial load time.

The system may also determine or estimate a fold for various browser/device combinations. The system may then wrap any elements of the page that are below the fold into a deferred I-Frame and removing the elements from the critical rendering path of the page. In this manner, any content of the page below the estimated fold may be delay loaded and, accordingly, not included into the initial load time performance analysis by the search engines.

In some implementations, the system may also utilize a browser simulator to load the page. During load, the system may monitor the page and determine what activity or elements are executing at load time. The system may then extract any elements that are not executed at load and repackage those elements as a delayed load unit. In other examples, the system may capture each element that is associated with the initial load and redraft the elements into HTML code. The system may then replace the page with the HTML code thereby removing any issues associated with elements, such as plugins.

In addition to simulating the browser and monitoring the load activity for individual pages, the system may apply one or more machine learned models or networks to assist with modifying the page code to improve performance and load time. For example, the system may include one or more models or networks trained using code associated with pages of a website to detect conditions as discussed above and to output code portions to improve performance. For instance, a page may be input into the model and as an output the model or network may provide a new header that integrates CSS modifications previously including in a plugin. As described herein, an exemplary model or network may include a neural network. The neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine learning, which can refer to a broad class of such algorithms in which an output is generated based on learned parameters

Although discussed in the context of networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

In some examples, the system may also process dynamic pages (e.g., pages that include customized content based on a user identifier or account information). In these cases, the system may determine portions of individual pages that operate as a static content (e.g., content not based on the user identifier or account information) and portions that operate as dynamic or individually customized content. For example, a machine learned model or network may sample the page as the pages are served to different user devices to determine the static content and the dynamic content. The system may then apply the process discussed above to the static portions and, thereby, improve load time and performance of the page.

As discussed herein, the maintenance and monitoring system is discussed as a separate system form the host system. however, it should be understood that the maintenance and monitoring system may be embedded as a component of the host system, integrated into the host system, or configured as multiple systems operating in conjunction with the host system.

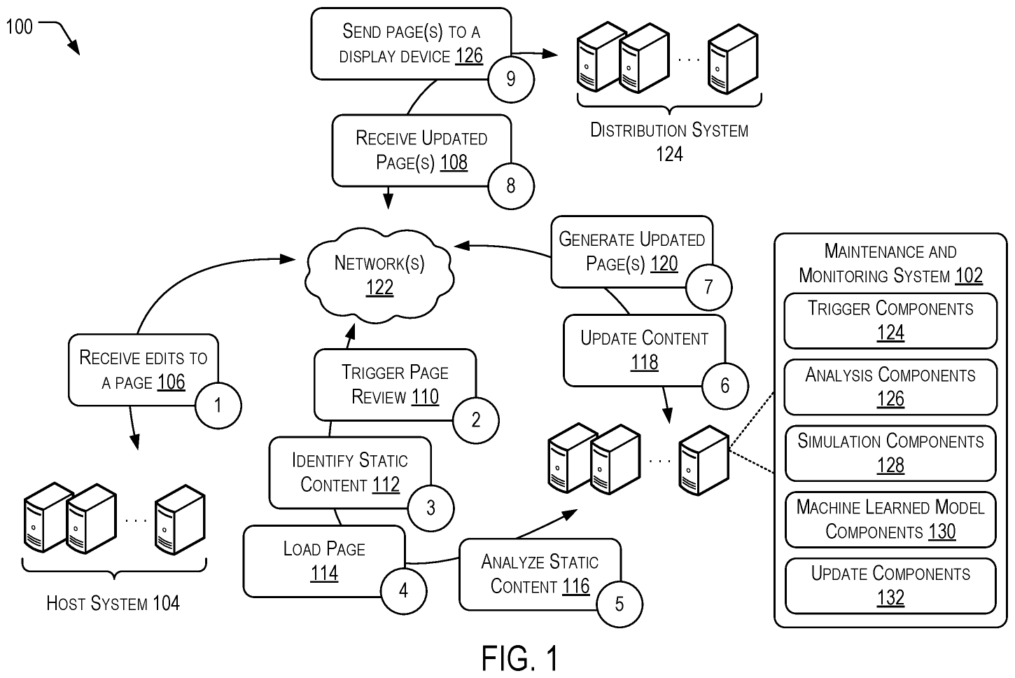

FIG. 1 is a view of an example 100 of a system 102 to improve website performance, according to some implementations. In the current example, the maintenance and monitoring system 102 may be associated with or otherwise configured to monitor and/or maintain one or more pages provided by the host system 104. In this manner, the system 102 may update, improve search ranking, and/or improve the performance of the one or more pages hosted by the host system 102.

With respect to FIG. 1, the host system 104 may, at operation 106 (indicated by “1”), receive edits to a page. For example, the host system responsible for maintaining the original page code and/or providing access to the code to the owner or programmer associated with the page may be configured to server the page in response to a request by a viewing or display device as, the page may be part or a portion of a website hosted by the host system 104. As an example, a user may edit content, update code (e.g., add, update, or remove a plugin), edit images or videos, and the like.

In this example, at operation 110 (indicated by “2”), the maintenance and monitoring system 102 may trigger a page review, such as in response to the initial hosting or updating of the page. For example, the maintenance and monitoring system 102 may detect the initial upload or edits to the page. In other cases, the trigger may also be in response to a notification or request sent by the host system 104 to the maintenance and monitoring system 102.

At operation 112 (indicated by “3”), the maintenance and monitoring system 102 may detect the static content of the page. That is, the maintenance and monitoring system 102 may identify content that is customized based on a user identity or login from the remaining content. The remaining content may be classified as static. In some cases, the system 102 may parse the loaded page and/or the original host code for the page to detect static portions of the loaded page. The system may also monitor the page or section/portions of the page through one or more user experiences (e.g., user sessions interacting with the page or pages of a website).

At operation 114 (indicated by “4”), the maintenance and monitoring system 102 may load the content of the page. For example, the system 102 may modify the DOMs to complete the page. As one illustrative example, a JavaScript may acts directly upon the DOM to cause modifications to the visually displayed page.

At operation 116 (indicated by “5”), the maintenance and monitoring system 102 may analyze the static content. For example, the system 102 may parse the loaded page, identify one or more instances of immediately-executable scripts, plugins, CSS elements, scripting languages (e.g., JavaScript code, Web Assembly Language, and the like), redundant code, image/video content or files, and the like.

In this example, at operation 118 (indicated by “6”), the maintenance and monitoring system 102 may update the page. For example, the maintenance and monitoring system 102 may modify the page code to improve load time as well as other performance related metrics. For example, the system 102 may then replace any identified immediately-executable scripts with newly generated static page html code. The system 102 may also remove CSS elements and/or plugin elements from the code and replace the CSS elements and/or the plugin elements with corresponding code or modifications to the CSS in a page header.

The system 102 may also consolidate any CSS code associated with the page as well as to remove code causing redundant changes during load time. For instance, two plugins may cause the same CSS modification. In these cases, the system 102 may identify the redundant changes and remove the corresponding code. In some case, the system 102 may also modify the page code to reduce the overall number and size of the files. For instance, by reducing the number of files (e.g., consolidating the files), the page may be loaded in a more efficient manner as the file access times are reduced. Likewise, the system 102 may partition oversized files into multiple files to, for instance, load in parallel.

In some examples, the maintenance and monitoring system 102 may also identify instances of JavaScript code (or other scripts, such as Web Assembly Languages) within the loaded page that are executed or referenced on load. The system 102 may then adjust the page code such that the load time elements of the JavaScript executes as an initial loadable unit and the remainder of the JavaScript elements are packaged as a delayed load or interactive load.

In some examples, the system 102 may also identify still images and/or video content associated with the loaded page. The system 102 may then generate a page for each of the browser/device combinations typically selected by the browser extension. The page may be served based on the requesting browser/device combination such that only a single image or a corresponding (e.g., reduced size) image is served by the host system 104. As an example, if a smart phone or tablet accesses the page, a smaller image may be served than if the access is via a personal computer or notebook. The system 102 may also determine or estimate a fold for various browser/device combinations. The system 102 may then wrap any elements of the loaded page that are below the fold into a deferred I-Frame and removing the elements from the critical rendering path of the page. In this manner, any content of the page below the estimated fold may be packaged as a delay loaded element or portion.

In some cases, the maintenance and motoring system 102 may be configured to simulate the page using various device/browser combination and/or to analyze the page code via one or more machine learned models. For instance, the system 102 may simulate the page loading using various virtual device/browser combinations to determine various metrics. During simulation, the system 102 may then extract any elements that are not executed at load and repackage as a delayed load unit.

At operation 120 (indicated by “7”), the system 102 may then update the website page and, the system 102 may provide the updated page (e.g., the updated page code) to a distribution system 124. Thus, at operation 108 (indicated by “8”), the distribution system 104 may receive the updated page(s). For example, the system 102 may send one or more pages (e.g., a page for each determined browser/device combination) to the distribution system 104.

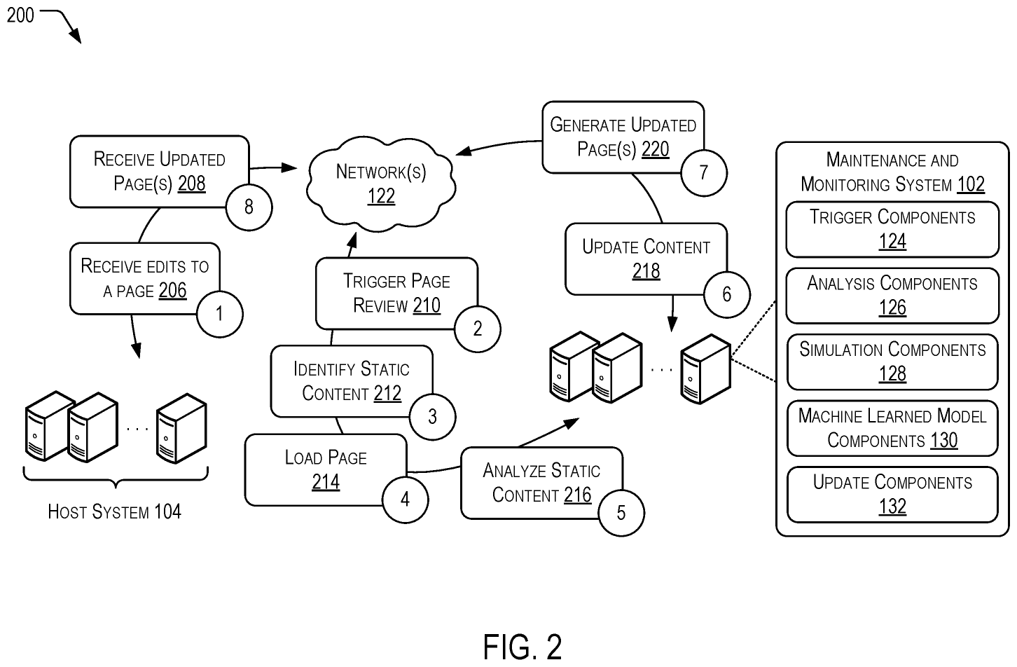

At operation 1226 (indicated by “8”), the distribution system 124 may send pages to a display device. For example, the display device may request or otherwise access a URL associated with the page and the distribution system 124 may server the updated page code as a response. In this example, the distribution system 124 is shown as a separate system from systems 102 and 104, however, in other examples, the distribution system 124 may be integrated into either or both of the systems 102 and/or 104. For example, in FIG. 2 below the distribution system 124 and the host system 104 may be the same.

In the illustrated example, the system 102 may include a number of components to improve the performance of the page and/or generate the updated page(s). For example, the system may trigger components 124, analysis components 126, simulation components 128, machine learned model components 130, and/or update components 132.

FIG. 2 is a view of an example 200 of a system 202 to improve website performance, according to some implementations. In the current example, the maintenance and monitoring system 202 may be associated with or otherwise configured to monitor and/or maintain one or more pages provided by the host system 204. In this manner, the system 202 may update, improve search ranking, and/or improve the performance of the one or more pages hosted by the host system 202.

With respect to FIG. 2, the host system 204 may, at operation 206 (indicated by “1”), receive edits to a page. For example, the host system may be configured to server the page in response to a request by a viewing device as, the page may be part or a portion of a website hosted by the host system 204. As an example, a user may edit content, update code (e.g., add, update, or remove a plugin), edit images or videos, and the like.

In this example, at operation 210 (indicated by “2”), the maintenance and monitoring system 202 may trigger a page review, such as in response to the initial hosting or updating of the page. For example, the maintenance and monitoring system 202 may detect the initial upload or edits to the page. In other cases, the trigger may also be in response to a notification or request sent by the host system 2104 to the maintenance and monitoring system 202.

At operation 212 (indicated by “3”), the maintenance and monitoring system 202 may detect the static content of the page. That is, the maintenance and monitoring system 202 may identify content that is customized based on a user identity or login from the remaining content. The remaining content may be classified as static. In some cases, the system 202 may parse the loaded page and/or the original host code for the page to detect static portions of the loaded page. The system may also monitor the page or section/portions of the page through one or more user experiences (e.g., user sessions interacting with the page or pages of a website).

At operation 214 (indicated by “4”), the maintenance and monitoring system 202 may load the content of the page. For example, the system 102 may modify the DOMs to complete the page. As one illustrative example, a JavaScript may acts directly upon the DOM to cause modifications to the visually displayed page.

At operation 216 (indicated by “5”), the maintenance and monitoring system 202 may analyze the static content. For example, the system 202 may parse the loaded page, identify one or more instances of immediately-executable scripts, plugins, CSS elements, scripting languages (e.g., JavaScript code, Web Assembly Language, and the like), redundant code, image/video content or files, and the like.

In this example, at operation 218 (indicated by “6”), the maintenance and monitoring system 202 may update the page. For example, the maintenance and monitoring system 202 may modify the page code to improve load time as well as other performance related metrics. For example, the system 102 may then replace any identified immediately-executable scripts with newly generated static page html code. The system 202 may also remove CSS elements and/or plugin elements from the code and replace the CSS elements and/or the plugin elements with corresponding code or modifications to the CSS in a page header.

The system 202 may also consolidate any CSS code associated with the page as well as to remove code causing redundant changes during load time. For instance, two plugins may cause the same CSS modification. In these cases, the system 202 may identify the redundant changes and remove the corresponding code. In some case, the system 202 may also modify the page code to reduce the overall number and size of the files. For instance, by reducing the number of files (e.g., consolidating the files), the page may be loaded in a more efficient manner as the file access times are reduced. Likewise, the system 202 may partition oversized files into multiple files to, for instance, load in parallel.

In some examples, the maintenance and monitoring system 202 may also identify instances of JavaScript code (or other scripts, such as Web Assembly Languages) within the loaded page that are executed or referenced on load. The system 202 may then adjust the page code such that the load time elements of the JavaScript executes as an initial loadable unit and the remainder of the JavaScript elements are packaged as a delayed load or interactive load.

In some examples, the system 202 may also identify still images and/or video content associated with the loaded page. The system 202 may then generate a page for each of the browser/device combinations typically selected by the browser extension. The page may be served based on the requesting browser/device combination such that only a single image or a corresponding (e.g., reduced size) image is served by the host system 204. As an example, if a smart phone or tablet accesses the page, a smaller image may be served than if the access is via a personal computer or notebook. The system 202 may also determine or estimate a fold for various browser/device combinations. The system 202 may then wrap any elements of the loaded page that are below the fold into a deferred I-Frame and removing the elements from the critical rendering path of the page. In this manner, any content of the page below the estimated fold may be packaged as a delay loaded element or portion.

In some cases, the maintenance and motoring system 202 may be configured to simulate the page using various device/browser combination and/or to analyze the page code via one or more machine learned models. For instance, the system 202 may simulate the page loading using various virtual device/browser combinations to determine various metrics. During simulation, the system 202 may then extract any elements that are not executed at load and repackage as a delayed load unit.

At operation 220 (indicated by “7”), the system 202 may then update the website page and, at operation 108 (indicated by “8”), the host system 204 may receive the updated page(s). For example, the system 202 may send one or more pages (e.g., a page for each determined browser/device combination) to the host system 204.

In the illustrated example, the system 202 may include a number of components to improve the performance of the page and/or generate the updated page(s). For example, the system may trigger components 224, analysis components 226, simulation components 228, machine learned model components 230, and/or update components 232.

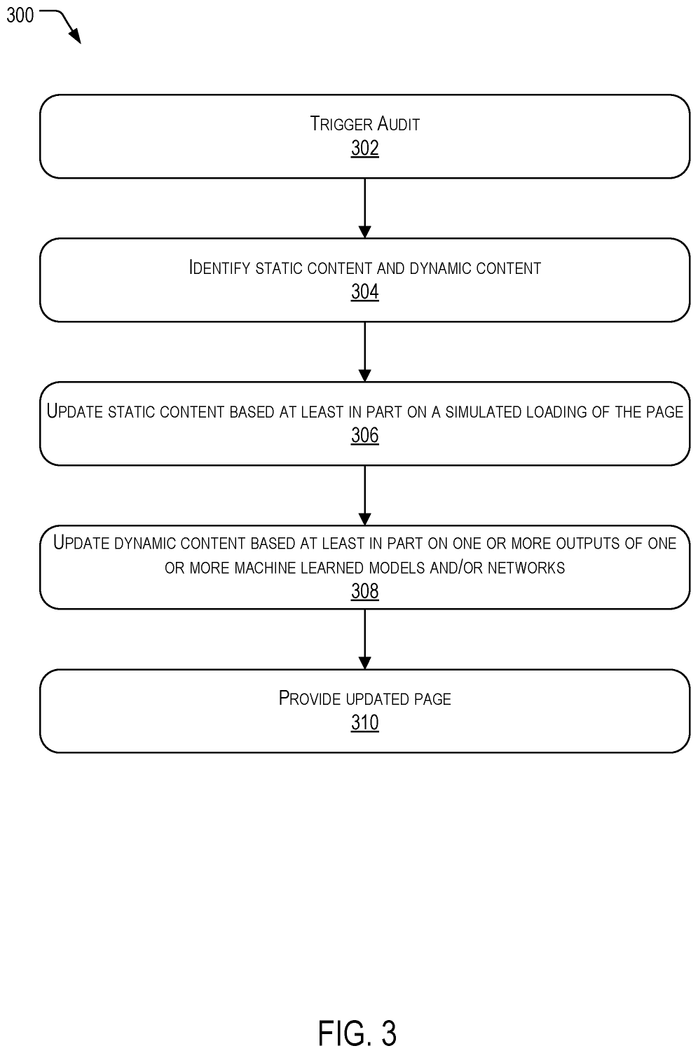

FIGS. 3-7 are flow diagrams illustrating example processes associated with the automatically updating pages of a website as discussed above. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a flow diagram illustrating an example process 300 associated with the system of FIG. 1 or 2 according to some implementations. As discussed above, a maintenance and motoring system may be configured to audit pages of one or more websites and to update the page code to improve the overall performance and/or decrease load and, thereby, improve the sites placement or ranking with respect to search engine results.

At 302, the system may trigger an audit of a page. For instance, the system may monitor the page for updates provided by an owner or developer associated with the page. In other cases, the audit may trigger in response to a request by the page owner or developer and/or in response to a period of time elapsing.

At 304, the system may identify static content and dynamic content. As discussed above the maintenance and monitoring system may identify content that is customized based on a user identity or login as dynamic content and the remaining content as static content even if the content may vary between accesses or views based on other criteria.

At 306, the system may update the static content based at least in part on a simulated loading of the page. For example, the maintenance and monitoring system may simulate the loading of the page using predetermined browser/device configurations and/or a custom or general browser. The system may monitor the code associated with the page as the page is loaded to determine various characteristics and/or conditions. The system may then update or otherwise alter the code associated with the page based on the loaded page, the characteristics, and/or the conditions, as discussed in more detail above and below with respect to FIGS. 3-7.

At 308, the system may update dynamic content based at least in part on one or more outputs of one or more machine learned models and/or networks. One or more models may be trained to provide code updates to dynamic content using training inputs such as multiple instances of the loaded page over multiple user identities and the like. In other examples, the system may monitor the page on multiple loads to learn what portions are static and what portions are dynamic. Likewise, the system may monitor the HTTP connection to detect queries or calls.

At 310, the system may provide an updated page to the server. In some cases, the system may require an approval by the owner or developer while in other cases the system may be preauthorized to replace the existing page code with the update page code.

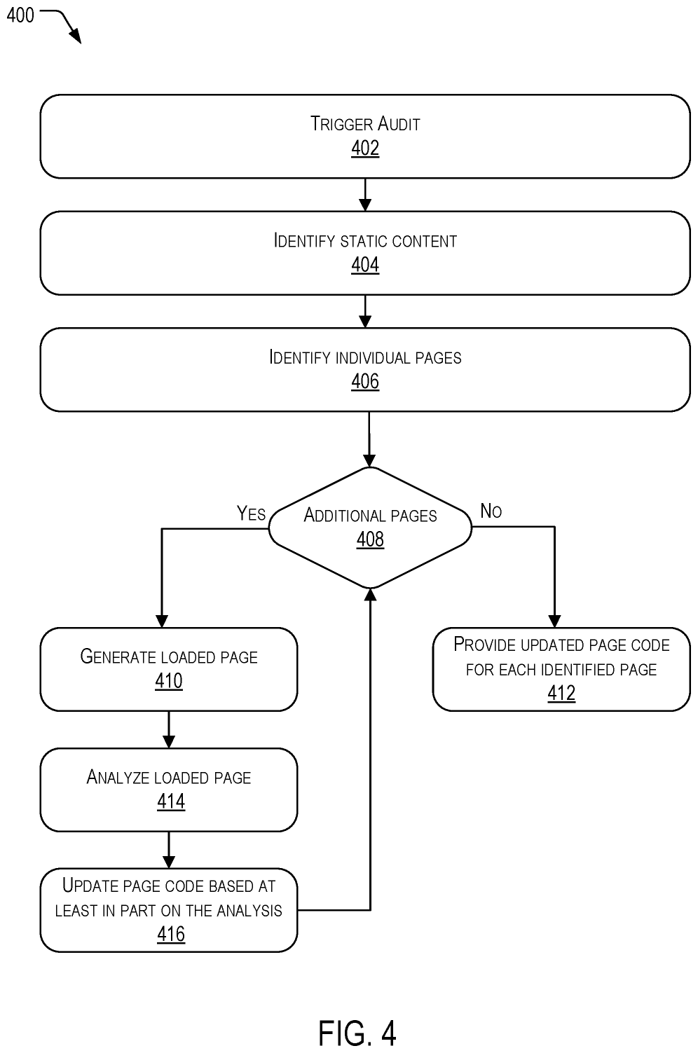

FIG. 4 is a flow diagram illustrating an example process 400 associated with the systems of FIG. 1 or 2 according to some implementations. In the current example, the process 300 illustrates updating the static content or portion of a website having multiple pages.

At 402, the system may trigger an audit of a page. For instance, the system may monitor the page for updates provided by an owner or developer associated with the page. In other cases, the audit may trigger in response to a request by the page owner or developer and/or in response to a period of time elapsing.

At 404, the system may identify static content (and/or dynamic content). As discussed above the maintenance and monitoring system may identify content that is customized based on a user identity or login as dynamic content and the remaining content as static content even if the content may vary between accesses or views based on other criteria.

At 406, the system may partition the site into individual pages. For example, the system may be configured to process each of the pages as an individual unit such that each page may be configured to improve performance, load time, and/or search result rankings. The system may then, at 408, determine if additional pages are being updated, audited, and/or evaluated. For instance, if an additional page exists, the process 400 may proceed to 410. Otherwise, the process 400 advances to 412. At 412, the system may provide the updated page code for each identified page to the host system, and thereby cause the host system to server the updated page code in lieu of the original page code when requested by a third-party device.

At 410, the system may generate a loaded page and, at 414, the system may analyze the loaded page (and/or the loading of the page). For example, the maintenance and monitoring system may simulate the loading of the page using predetermined browser/device configurations and/or a custom or general browser. The system may monitor the code associated with the page as the page is loaded to determine various characteristics and/or conditions.

At 416, the system may update page code based at least in part on the analysis. For example, the system may update or otherwise alter the code associated with the page based on the content of the loaded page and/or the characteristics and/or the conditions associated with the loading process, as discussed in more detail above and below. Once the system has updated the page code, the process 400 may return to 408 and determine if there are any additional pages to be processed.

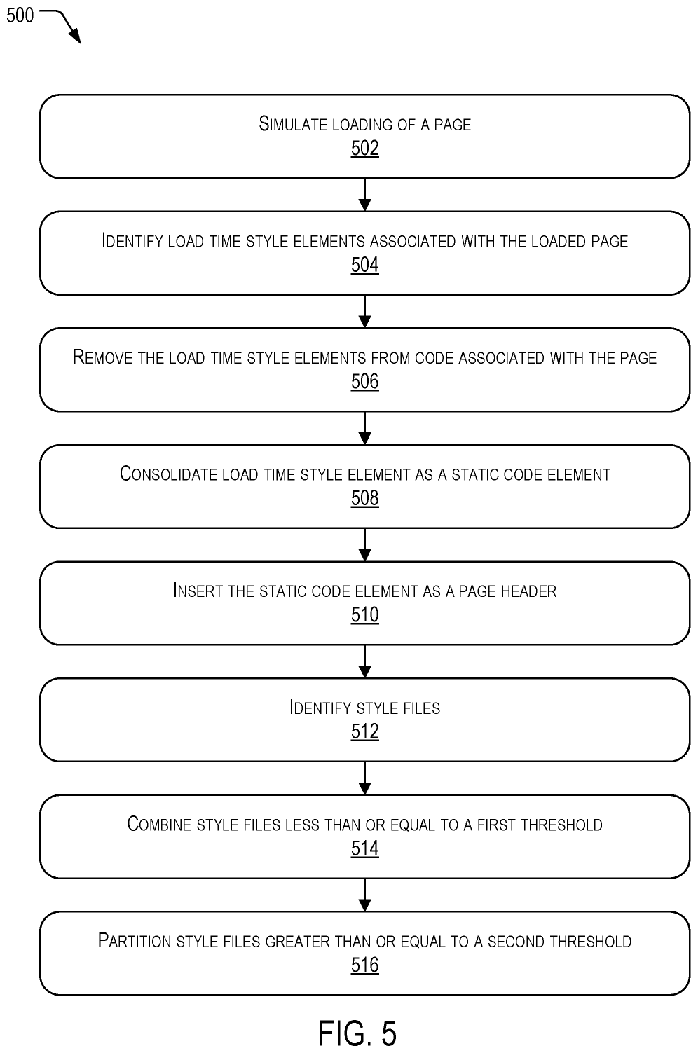

FIG. 5 is a flow diagram illustrating an example process 500 associated with updating page code according to some implementations. As discussed above, the system may update page code to improve performance, network resource consumption, load time, and search engine result ranking. For instance, in some examples, a user or owner of a site may register a website, page, or URL with the system. The system may then access the code of the website to perform an initial audit and/or update as well as various regular audits and/or updates, such as periodic or time-based audits, administrator triggered audits, website update triggered audits (e.g., the website owner updates the site content or code), and the like. During an audit, the system may perform various tests and measure performances (such as initial load time) and apply various code optimizations and/or updates based on the results of the tests.

At 502, the system may simulate loading of a page to generate a loaded HTML page. For instance, the system may monitor load time, detect style elements (such as CSS elements) that are updated or referred on load, scripts or languages (such as JavaScript code, Web Assembly Language code, and the like) that are referenced or not referenced on load, and the like. The system may utilize preconfigured or preselected browser/device combinations as well as a generic browser/device configuration to simulate loading of the page. In some cases, the simulation may be performed with respect to multiple browser/device configurations.

At 504, the system may identify instances of CSS elements and/or plugins that modify the CSS of the page. For example, many scripting languages and/or page content management systems allow users to insert plugins or code segments (such as open source code segments) that are self-contained and include CSS modifications associated with the plugin to cause the plugin to display appropriately without custom coding. However, pages that include plugins have slower load times resulting in these pages ranking lower with respect to pages that were custom built by an experienced programmer. In these cases, the system, discussed herein, may identify the CSS elements associated with the plugins that modify the CSS of the page.

At 506, the system may then remove the style elements (e.g., the CSS elements) from the code associated with the plugin reducing the load time associated with incorporating the plugin in the page code.

At 508, the system may consolidate load time style elements as static code elements and, at 510, the system may insert the static code elements (e.g., the consolidated load time style elements) as a page header. For example, after removing the load time style elements, the system may consolidate the style elements as HTML code that may be used as a header for the page. In this manner, redundant elements may be applied a single time and all style elements are loaded as a single package reducing load time edits to the style sheets.

At 512, the system may also identify the style files (such as independent CSS files) and, at 514, the system may combine the style files less than or equal to a first threshold. For example, by reducing the number of CSS files (e.g., consolidating the files), the page may be loaded in a more efficient manner as the file access times are reduced (e.g., each access includes a fixed file access time that is no longer applicable).

At 516, the system may also partition style files greater than or equal to a second threshold. For example, if a CSS file is too large the file may be partitioned into multiple files to, for instance, load in parallel, thereby reducing load time.

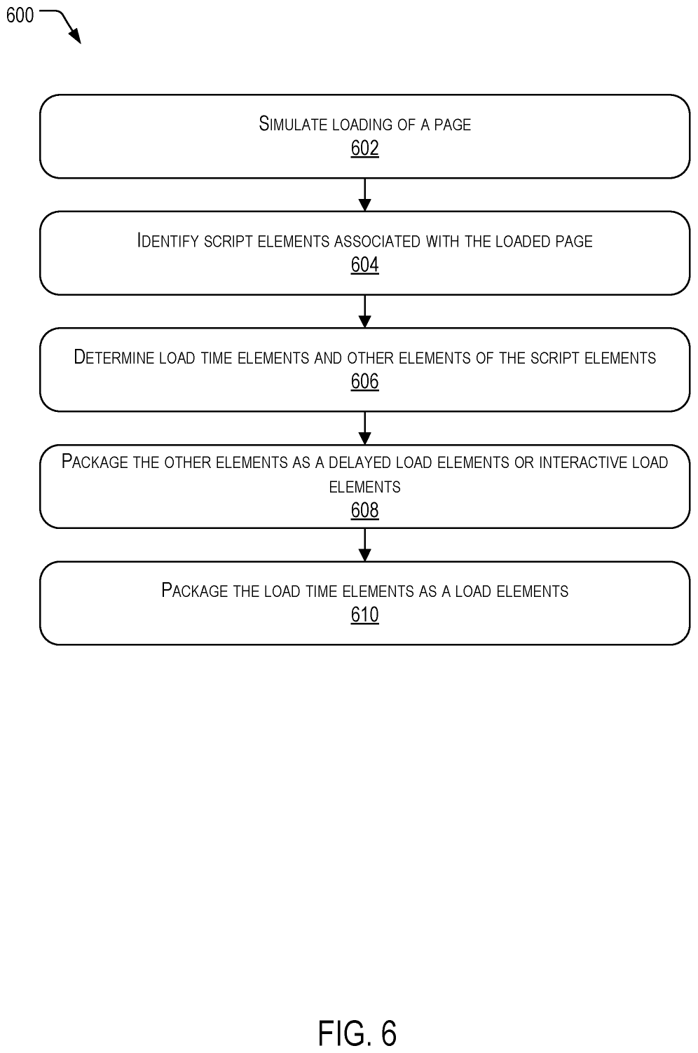

FIG. 6 is a flow diagram illustrating an example process 600 associated with updating page code according to some implementations. As discussed above, the system may update page code to improve performance, network resource consumption, load time, and search engine result ranking. For instance, in some examples, a user or owner of a site may register a website, page, or URL with the system. The system may then access the code of the website to perform an initial audit and/or update as well as various regular audits and/or updates, such as periodic or time-based audits, administrator triggered audits, website update triggered audits (e.g., the website owner updates the site content or code), and the like. During an audit, the system may perform various tests and measure performances (such as initial load time) and apply various code optimizations and/or updates based on the results of the tests.

At 602, the system may simulate loading of a page to generate a loaded HTML page. For instance, the system may monitor load time, detect style elements (such as CSS elements) that are updated or referred on load, JavaScript that are referenced or not reference on load, and the like. The system may utilize preconfigured or preselected browser/device combinations as well as a generic browser/device configuration to simulate loading of the page. In some cases, the simulation may be performed with respect to multiple browser/device configurations.

At 604, the system may identify instances of script elements associated with the loaded page. For example, the system may also identify instances of JavaScript code within the loaded page and monitor the JavaScript during testing to determine first elements of the JavaScript that are executed or referenced on load.

At 606, the system may determine load time elements and other elements of the script elements. For instance, JavaScript may include the first elements that are executed or referenced on load and other elements that are executed at a later time or unreferenced on load.

At 608, the system may package the other elements as delayed load elements or interactive load elements and, at 610, the system may package the load time elements as load elements. For example, the system may adjust the page code such that the load time elements of the JavaScript executes as an initial loadable unit and the other elements are packaged as a delayed load or interactive load thereby reducing load time code execution and improving the overall load time of the page. In this manner, only the elements refenced at load time are executed during load and the other elements are executed at a later time.

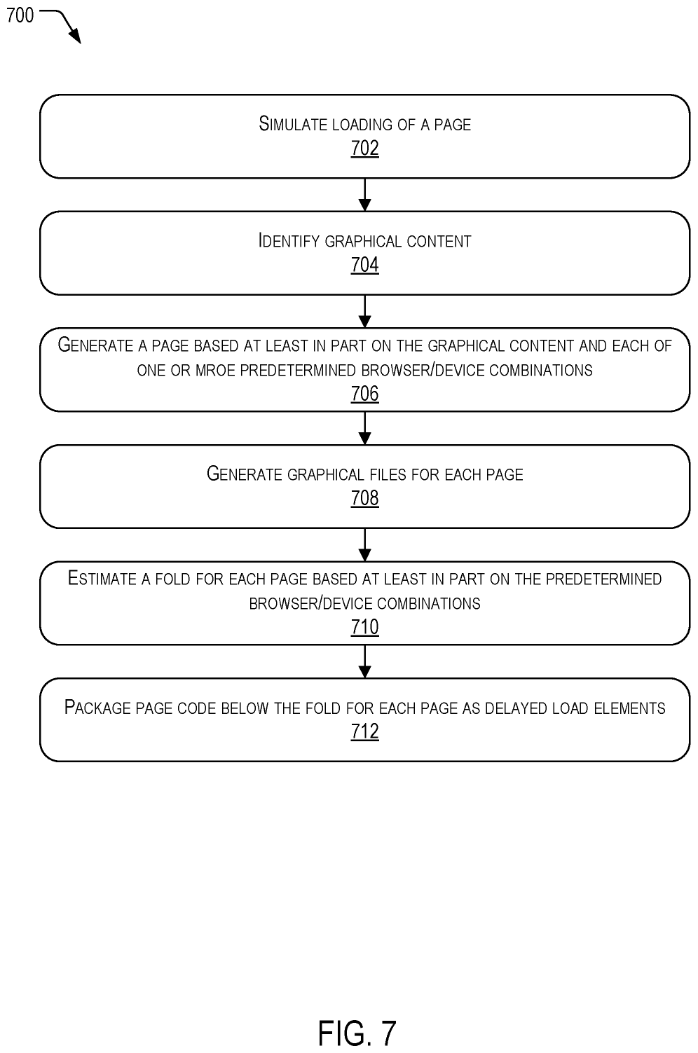

FIG. 7 is a flow diagram illustrating an example process 700 associated with updating page code according to some implementations. As discussed above, the system may update page content (such as graphical elements) to improve performance, network resource consumption, load time, and search engine result ranking.

At 702, the system may simulate loading of a page to generate a loaded HTML page. For instance, the system may monitor load time, detect image and/or video elements above the fold, and the like. The system may utilize preconfigured or preselected browser/device combinations as well as a generic browser/device configuration to simulate loading of the page. In some cases, the simulation may be performed with respect to multiple browser/device configurations.

At 704, the system may identify graphical content or elements of the page. For example, the system may identify icons, images, graphs, videos, and the like. In some instances, the system may identify each graphical element while in other cases the system may identify graphical elements above a fold based on, for instance, a predetermined browser/device combination.

At 706, the system may generate a page based at least in part on the graphical content and each of one or more predetermined browser/device combinations and, at 708, the system may generate graphical files for each page. For example, the system may resize the graphical elements or content and generate corresponding page code for each of the predetermined browser/device combinations. In this manner, the host system may serve corresponding page code in response to a request by a matching or closest matching request by a browser/device configuration (e.g., the closeness between the predetermined browser/device and the requesting browser/device configuration).

At 710, the system may estimate a fold for each page based at least in part on the predetermined browser/device combination. For example, the portion of the page above the fold may be smaller when a smart phone or tablet is accessing the page than when the page is accessed via a personal computer or notebook. In this case, the system may determine a fold for each of the predetermined browser/device combination.

At 712, the system may package page code below the fold for each page as a delayed load elements. For example, for each page code the system may utilize the estimated fold to determine the load time portion of the page and the delayed load portion of the page. The elements of the page in the delayed load portion may then be packaged as delayed load elements to improve the load time and search ranking associated with the page. It should be understood that for each predetermined browser/device combination, the system may generate individual page code having differing delayed load elements, such that the host system may serve the corresponding page code based on the requesting browser/device configuration to improve load time on various different platforms. In some cases, the system may wrap any delayed load elements of the page that are below the fold into a deferred I-Frame and remove the corresponding elements from the critical rendering path of the page. In this manner, any content of the page below the estimated fold may be delay loaded and, accordingly, not included into the initial load time performance analysis by the search engines.

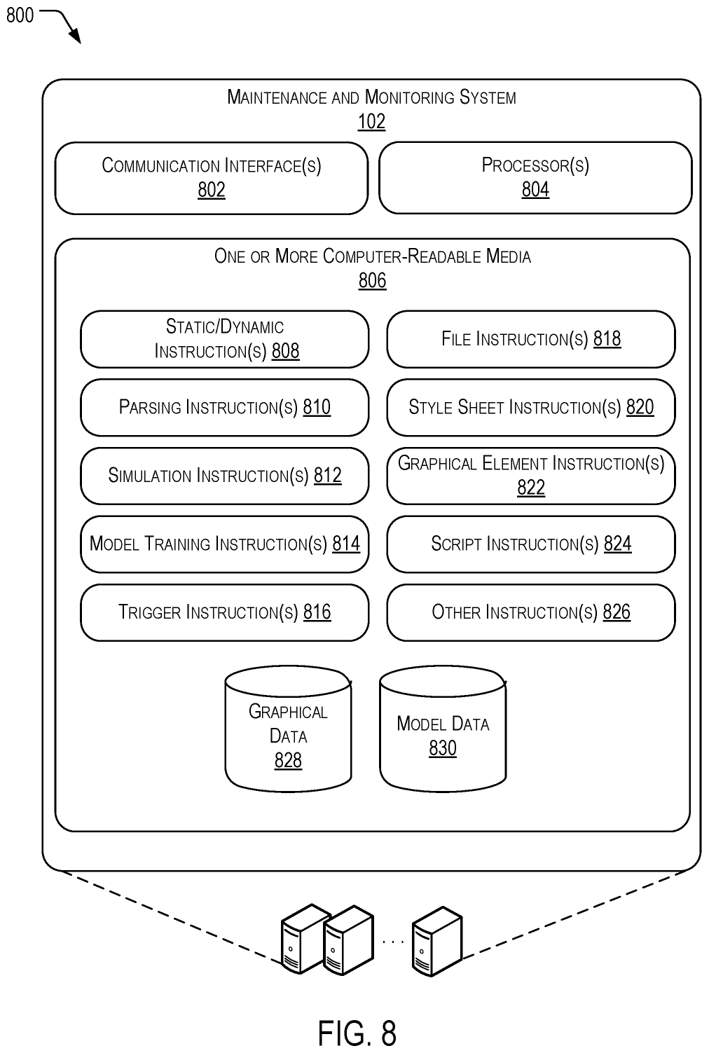

FIG. 8 is an example 800 of a maintenance and monitoring system 102 (or 202) application according to some implementations. As described above, the maintenance and monitoring system 102 may be configured to access, audit, update, and/or optimize individual web pages of a website via an automated process to improve load time, network resource consumption, and search engine result rankings. In some examples, a user or owner of a page may register a website, page, or URL with the system 102. The system 102 may then access the page code of the website to perform an initial audit and/or update as well as various regular audits and/or updates, such as periodic or time-based audits, administrator triggered audits, website update triggered audits (e.g., the website owner updates the site content or code), and the like. During an audit, the system 102 may perform various tests and measure performances (such as initial load time) and apply various code optimizations and/or updates based on the results of the tests.

The maintenance and monitoring system 102 may also include one or more communication interfaces 802 configured to facilitate communication between one or more networks and/or one or more cloud-based services, such as host system 104 or distribution system 124 of FIG. 1, and the like. The communication interfaces 802 may also facilitate communication between one or more wireless access points, a master device, and/or one or more other computing devices as part of an ad-hoc or home network system. The communication interfaces 802 may support both wired and wireless connection to various networks, such as cellular networks, radio, WiFi networks, short-range or near-field networks (e.g., Bluetooth®), infrared signals, local area networks, wide area networks, the Internet, and so forth.

The maintenance and monitoring system 102 may also include one or more processors 804, such as at least one or more access components, control logic circuits, central processing units, or processors, as well as one or more computer-readable media 806 to perform the function associated with the virtual environment. Additionally, each of the processors 804 may itself comprise one or more processors or processing cores.

Depending on the configuration, the computer-readable media 806 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 804.

Several modules such as instruction, data stores, and so forth may be stored within the computer-readable media 806 and configured to execute on the processors 804. For example, as illustrated, the computer-readable media 806 may store static/dynamic instructions 808, parsing instructions 810, simulation instructions 812, model training instructions 814, trigger instructions 816, file instructions 818, style sheet instructions 820, graphical element instructions 822, script instructions 824, as well as other instructions 826, such as operating instructions. The computer-readable media 806 may also store data usable by the instructions 808-826 to perform operations. The data may include graphical data 828 and model data 830.

The static/dynamic instructions 808 may be configured to determine portions of a loaded page that are static and portions of a page that are dynamic. As used discussed above, a dynamic portion of a page is any portion that delivers personalized content based on a known user login or account accessing the page. The static pages are any other portions of the page that does not qualify as a dynamic portion. In some cases, the system 102 may cause the page to be loaded and the monitor the content being delivered to the requesting device in order to determine if content is dynamic or static.

The parsing instructions 810 may be configured to parse the page code and/or the loaded page code to detect elements of a page. For example, the parsing instructions 810 may cause the system 102 to identify graphical elements, scripts (e.g., JavaScripts), system elements (e.g., CSS elements), plugins, and the like.

The simulation instructions 812 may be configured to cause the page to load and generate loaded page code. In some cases, the simulation instructions 812 may cause the page to load multiple times for various predetermined browser/device combinations in order to determine load time for different software/hardware configurations as well as estimate a fold location with respect to the specific combinations.

The model training instructions 814 may be configured to train one or more machine learned model and/or network to determine dynamic portions of the page as well as to recommend, generate, and update page code associated with the dynamic portions to improve performance, network usage, load time, and the like.

The trigger instructions 816 may be configured to trigger an audit or code update for one or more pages. For instance, the trigger instructions 816 may initiate an audit in response to a request or notification of an update from the system hosting the page, various time period elapsing, and/or other criterion.

The file instructions 818 may be configured to consolidate and/or partition style or CSS files and the like to improve overall load time. For example, by consolidating smaller files, the number of file access required to load the page may be reduced, while partitioning larger files may allow some elements of the page to load in parallel.

The style sheet instructions 820 may be configured to consolidate and remove redundant CSS changes caused by various plugins. The sheet instructions 820 may also be configured to generate a page header that include all of the detected CSS edits such that the style elements may be loaded as a single unit.

The graphical element instructions 822 may be configured to resize or generate copies of graphical elements for various instances of the pages to reduce overall load time or file transfer time.

The script instructions 824 may be configured to identify instances of scripts (such as JavaScript code) within the loaded page and monitor the scripts during testing to determine first elements of the scripts that are executed or referenced on load. For instance, scripts may include the first elements that are executed or referenced on load and other elements (e.g., second elements) that are executed at a later time or unreferenced on load. Once, the first elements of the scripts are identified, the system may adjust the page code such that the first elements of the scripts executes as an initial loadable unit and the second elements are packaged as a delayed load or interactive load thereby reducing load time code execution and improving the overall load time of the page. In some cases, either the first elements and/or the second elements of the scripts may include modifications to the CSS tree. In these case, similar to the plugins discussed above, the system may consolidate and move the CSS modifications to the header to further improve load time performance of pages utilizing scripts.

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples. For example, the components and instructions of FIG. 8 may utilize the processes and flows of FIGS. 1-6.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

### Example Clauses

A. A method comprising: loading of a source page code including a document object model (DOM) parsing a representation of the loaded page to identify dependencies among DOM objects of the DOM, reordering the DOM objects within the loaded page to reduce load time of the page; generating equivalent page code based at least in part on the reordering of the DOM objects within the loaded page; and sending the equivalent page code to a remote system.

B. The method of paragraph A, wherein generating the equivalent page code further comprises relocating style elements towards the beginning of the equivalent page code with respect to the source page code.

C. The method of paragraph A, wherein generating the equivalent page code further comprises: determining dependencies between active programming elements and DOM objects; and relocating active programming elements proximate to a beginning of the equivalent page code.

D. The method of paragraph A, wherein generating the equivalent page code further comprises removing unreferenced style elements from the equivalent page code.

E. The method of paragraph D, wherein the unreferenced style elements are cascading style sheet (CSS) elements.

F. The method of paragraph A, wherein generating the equivalent page code further comprise: identifying an active programming element within the loaded page; and modifying the active programming element to include a delayed-loading feature.

G. The method of paragraph A, wherein: generating the equivalent page code further comprises: identifying graphical elements referenced by the DOM objects, style objects, or active programming objects; and responsive to, identifying the graphical elements, caching the graphical elements in a content delivery network.

H. The method of paragraph A, wherein generating the equivalent page code further comprises: identifying style objects or active programming objects; determining that the style objects or the active programming objects function is not impaired by a consolidation operation; and executing the consolidation operation, in response to determining the function is not impaired, the consolidation operation to consolidate the CSS objects or the active programming objects into one or more combined objects.

I. The method of paragraph A, wherein generating the equivalent page code further comprises: identifying loaded hypertext markup language (HTML) files, style sheet files and active programming language files, and consolidating the HTML files, style sheet files, and the active programming language files to load as a single file.

J. The method of paragraph A, wherein generating the equivalent page code further comprises: inputting the loaded page into one or more machine learned models, the one or more machine learning models; receiving, as an output of the one or more machine learned models, one or more consolidation and compression parameters; applying the one or more consolidation and compression parameters to a plurality of browser, device, and bandwidth configurations associated with the loaded page to generate one or more results, and selecting at least one of the one or more the file consolidation and compression parameters to apply to one or more files based at least in part on the comparison of the one or more results.

K. The method of paragraph A, wherein the representation of the loaded page is at least one of a: a textual representation; or an DOM model equivalent of the textual representation.

L. The method of paragraph A, wherein responsive to a request to view the page, the equivalent page code is severed.

M. A method comprising: performing a set of iterations until a threshold is met or exceeded, individual iterations comprising: determining a plurality of parameters associated with a page; causing the page to load based at least in part on the plurality of parameters; determining load time optimizations associated with the page; and detecting a common load time optimization associated with at least a first iteration and a second iteration of the set of iterations; generating an updated page based at least in part on the page and the common load time optimization; and; providing the updated page to a host system for severing the updated page to a requesting third-party device.

N. The method of paragraph M, wherein the set of iterations and the common load time optimization further comprises: a result of parsing a database of a plurality of pages in an authoring framework.

O. The method of paragraph M, further comprising: inputting results of the set of iterations into one or more machine learning models; receiving from the one or more machine learned models an identification of dynamic content and static content; determining a plurality of parameters associated with the updated page based at least in part on the identification of the dynamic content and the static content; and wherein the plurality of parameters are utilized by the host system when serving the updated page.

P. The method of paragraph M, further comprising: inputting results of the set of iterations into one or more machine learning models; receiving from the one or more machine learned models a plurality of parameters associated with the updated page; and wherein the plurality of parameters are utilized by the host system when serving the updated page.

Q. A non-transitory computer-readable medium storing instructions that, when executed, cause one or more processors to perform operations comprising: loading of a source page code including a document object model (DOM); determining the DOM is fully formed and a loaded page has been generated; parsing a representation of the loaded page to identify dependencies among DOM objects of the DOM, reordering the DOM objects within the loaded page to reduce load time of the page; generating equivalent page code based at least in part on the reordering of the DOM objects within the loaded page; and sending the equivalent page code to a remote system.

R. The non-transitory computer-readable medium of paragraph Q, wherein generating the equivalent page code further comprises: determining dependencies between active programming elements and DOM objects; and relocating active programming elements proximate to a beginning of the equivalent page code.

S. The non-transitory computer-readable medium of paragraph Q, identifying an active programming element within the loaded page; and modifying the active programming element to include a delayed-loading feature.

T. The non-transitory computer-readable medium of paragraph Q, wherein generating the equivalent page code further comprises: identifying style objects or active programming objects; determining that the style objects or the active programming objects function is not impaired be consolidation; and consolidating, in response to determining the function is not impaired, the CSS objects or the active programming objects into a combined object.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

1. A method comprising:
loading of a source page code including a document object model (DOM);
parsing a representation of the loaded page to identify dependencies among DOM objects of the DOM;
reordering the DOM objects within the loaded page to reduce load time of the page;
generating equivalent page code based at least in part on the reordering of the DOM objects within the loaded page; and
sending the equivalent page code to a remote system.

2. The method of claim 1, wherein generating the equivalent page code further comprises:
determining dependencies between active programming elements and DOM objects; and
relocating active programming elements proximate to a beginning of the equivalent page code.

3. The method of claim 1, wherein generating the equivalent page code further comprise:
identifying an active programming element within the loaded page; and
modifying the active programming element to include a delayed-loading feature.

4. The method of claim 1, wherein:
generating the equivalent page code further comprises:
identifying graphical elements referenced by the DOM objects, style objects, or active programming objects; and
responsive to, identifying the graphical elements, caching the graphical elements in a content delivery network.

5. The method of claim 1, wherein generating the equivalent page code further comprises:
identifying style objects or active programming objects;
determining that the style objects or the active programming objects function is not impaired by a consolidation operation; and
executing the consolidation operation, in response to determining the function is not impaired, the consolidation operation to consolidate the CSS objects or the active programming objects into one or more combined objects.

6. The method of claim 1, wherein generating the equivalent page code further comprises:
identifying loaded hypertext markup language (HTML) files, style sheet files and active programming language files; and
consolidating the HTML files, style sheet files, and the active programming language files to load as a single file.

7. The method of claim 1, wherein generating the equivalent page code further comprises:
inputting the loaded page into one or more machine learned models, the one or more machine learning models;
receiving, as an output of the one or more machine learned models, one or more consolidation and compression parameters;
applying the one or more consolidation and compression parameters to a plurality of browser, device, and bandwidth configurations associated with the loaded page to generate one or more results; and
selecting at least one of the one or more the file consolidation and compression parameters to apply to one or more files based at least in part on the comparison of the one or more results.

8. A method comprising:
performing a set of iterations until a threshold is met or exceeded, individual iterations comprising:
determining a plurality of parameters associated with a page;
causing the page to load based at least in part on the plurality of parameters;
determining load time optimizations associated with the page; and
detecting a common load time optimization associated with at least a first iteration and a second iteration of the set of iterations;
generating an updated page based at least in part on the page and the common load time optimization; and
providing the updated page to a host system for severing the updated page to a requesting third-party device.

9. The method of claim 8, wherein the set of iterations and the common load time optimization further comprises:
a result of parsing a database of a plurality of pages in an authoring framework.

10. The method of claim 8, further comprising:
inputting results of the set of iterations into one or more machine learning models;
receiving from the one or more machine learned models an identification of dynamic content and static content;
determining a plurality of parameters associated with the updated page based at least in part on the identification of the dynamic content and the static content; and
wherein the plurality of parameters are utilized by the host system when serving the updated page.

11. The method of claim 8, further comprising:
inputting results of the set of iterations into one or more machine learning models;
receiving from the one or more machine learned models a plurality of parameters associated with the updated page; and
wherein the plurality of parameters are utilized by the host system when serving the updated page.

12. One or more non-transitory computer-readable media storing instructions that, when executed, cause one or more processors to perform operations comprising:
loading of a source page code including a document object model (DOM);
determining the DOM is fully formed and a loaded page has been generated;
parsing a representation of the loaded page to identify dependencies among DOM objects of the DOM;
reordering the DOM objects within the loaded page to reduce load time of the page;
generating equivalent page code based at least in part on the reordering of the DOM objects within the loaded page; and
sending the equivalent page code to a remote system.

13. The one or more non-transitory computer-readable media as recited in claim 12, wherein generating the equivalent page code further comprises:
determining dependencies between active programming elements and DOM objects; and
relocating active programming elements proximate to a beginning of the equivalent page code.

14. The one or more non-transitory computer-readable media as recited in claim 12, wherein generating the equivalent page code further comprise:
identifying an active programming element within the loaded page; and
modifying the active programming element to include a delayed-loading feature.

15. The one or more non-transitory computer-readable media as recited in claim 12, wherein generating the equivalent page code further comprises:
identifying style objects or active programming objects;
determining that the style objects or the active programming objects function is not impaired be consolidation; and
consolidating, in response to determining the function is not impaired, the CSS objects or the active programming objects into a combined object.

16. The one or more non-transitory computer-readable media as recited in claim 12, generating the equivalent page code further comprises:
identifying graphical elements referenced by the DOM objects, style objects, or active programming objects; and
responsive to, identifying the graphical elements, caching the graphical elements in a content delivery network.

17. The one or more non-transitory computer-readable media as recited in claim 12, wherein generating the equivalent page code further comprises:
identifying loaded hypertext markup language (HTML) files, style sheet files and active programming language files; and
consolidating the HTML files, style sheet files, and the active programming language files to load as a single file.

18. The one or more non-transitory computer-readable media as recited in claim 12, wherein generating the equivalent page code further comprises:
inputting the loaded page into one or more machine learned models, the one or more machine learning models;
receiving, as an output of the one or more machine learned models, one or more consolidation and compression parameters;
applying the one or more consolidation and compression parameters to a browser configuration associated with the loaded page to generate one or more results; and
selecting at least one of the one or more the file consolidation and compression parameters to apply to one or more files based at least in part on the comparison of the one or more results.

19. The one or more non-transitory computer-readable media as recited in claim 12, wherein generating the equivalent page code further comprises:
inputting the loaded page into one or more machine learned models, the one or more machine learning models;
receiving, as an output of the one or more machine learned models, one or more consolidation and compression parameters;
applying the one or more consolidation and compression parameters to a device configuration associated with the loaded page to generate one or more results; and
selecting at least one of the one or more the file consolidation and compression parameters to apply to one or more files based at least in part on the comparison of the one or more results.

20. The one or more non-transitory computer-readable media as recited in claim 12, wherein generating the equivalent page code further comprises:
inputting the loaded page into one or more machine learned models, the one or more machine learning models;
receiving, as an output of the one or more machine learned models, one or more consolidation and compression parameters;
applying the one or more consolidation and compression parameters to a bandwidth configuration associated with the loaded page to generate one or more results; and
selecting at least one of the one or more the file consolidation and compression parameters to apply to one or more files based at least in part on the comparison of the one or more results.
